(19) United States
(12) Patent Application Publication
(10) Pub. No.: US 2007/0229059 A1
(43) Pub. Date: Oct. 4, 2007

(54) Position Determination Device and Method of Position Determination

(75) Inventors: Peter Kunow, Berlin (DE); Klaus Biester, Wienhausen (DE)

Correspondence Address: CONLEY ROSE, P.C.;David A. Rose, PO BOX 3267, HOUSTON, TX, 77253-3267, US

(73) Assignee: CAMERON INTERNATIONAL CORPORATION, Houston, TX (US)

(21) Appl. No.: 11/568,097

(22) PCT Filed: Apr. 23, 2004
(86) PCT No.: PCT/EP04/04343

§ 371 Date: Oct. 19, 2006

(30) Foreign Application Priority Data
Apr. 23, 2004 (DE) PCTEP2004004343

(51) Int. Cl. G01B 7/14

(52) U.S. Cl. 324/207.24

(57) ABSTRACT

The position determination device for an essentially linear moving body comprises at least one deformation element extending along the range of body movement, a deformation initiation device movable relative to said deformation element, a deformation sensor assigned to a measurement end of the deformation element and an evaluation unit for determining the position from a propagation time required from the deformation of the deformation initiation element to the deformation sensor. To determine the position of corresponding body, first a brief deformation is induced in the deformation element at an initiation point in which the deformation initiation element is located. Then, a propagation time of at least one oscillation caused by the deformation along the deformation element is measured at a measuring point of the deformation element using the deformation sensor. Finally, the distance between the initiation point and the measuring point is calculated from the propagation time for the position determination of two bodies relative to each other.

The invention relates to a position determination device and an associated method of position determination.

The device and method are used to determine the position of a body, in particular a spindle of a screw drive, which is employed in an actuator in the production of mineral oil or natural gas. This type of actuator is used, for example, in the adjustment and actuation of blowout preventers, valves, throttles and similar equipment. The relevant screw drive is driven by at least one electric motor and the relative position between the spindle and the associated spindle nut is determined in order to infer a corresponding position of the element operated by the actuator.

From DE 20 203 298, for example, an appropriate position determination device is known in which a bar code is arranged on an element and a corresponding scanning device is arranged on another element which move relative to one another. The appropriate bar code is here specific to position so that by reading out the bar code the relative position of both elements with respect to one another can be found.

The previously known sensor operates quite satisfactorily. However, the bar code has to be specially manufactured and the associated scanning device is sometimes not easy to integrate into the appropriate body, such as the spindle or similar component, of an actuator. In addition, the previously known sensor is partially sensitive to external influences, such as variations in the pressure or temperature.

The object of the invention is to improve a position determination device and an associated method such that external influences are largely negligible during the simple, accurate and reproducible determination of a position. At the same time the said device is simply constructed and can be easily integrated in the actuators mentioned above or in similar equipment.

The object is solved by the features of patent claims 1 and 26.

According to the invention, a deformation element is assigned to one of the moving bodies and a deformation initiation element to the other body. These elements move relative to one another analogous to the bodies. In the deformation element a deformation is briefly induced at an initiation point where the deformation initiation element is currently located. Then, a propagation time of at least one oscillation caused by the deformation and propagating along the deformation element is measured by a suitable deformation sensor. From the propagation time, the distance between the initiation point and measuring point is calculated for the corresponding position determination.

With the said position determination device a deformation element extends along a body movement section in which the corresponding movable body moves essentially linearly. A deformation initiation element is movable relative to the deformation element.

A deformation sensor is particularly assigned to a measurement end of the deformation element. Finally, an evaluation unit is provided for the position determination from a propagation time required from the deformation of the deformation initiation element to the deformation sensor.

According to the invention, no special bar codes or similar features are needed which have to be manufactured separately. It is also no longer necessary for the said sensor to move corresponding to changes of the position to be determined along the corresponding position-specific pattern. Instead of this, according to the invention, a determination of the position at a fixed point can be carried out, whereby the different positions are given by propagation times of the corresponding induced deformation. Consequently, the position determination device according to the invention is simply constructed and fewer parts need to be manufactured with the appropriate accuracy and moved relative to one another. The said sensor can be accommodated at a secure point where it is protected from damage or dirt. In addition the type of position determination, according to the invention, and the device used for it are relatively insensitive with respect to external influences such as pressure, temperature, temperature changes or similar effects or corresponding dependencies can at least be compensated in a simple manner.

With a preferred embodiment of the invention the deformation element can be essentially tubular. There is then the possibility that the deformation can be initiated at some point in the circumferential direction or over the complete circumference at an appropriate point.

The initiation and the propagation of the deformation can furthermore be simplified in that the deformation element is thin-walled. A material for such a thin-walled deformation element may be, for example, aluminium. Other elastically deformable materials are also possible. Similarly, the deformation element can also be formed from a solid material. Another embodiment of a deformation element is a coil or a winding of a series of single windings. The single windings here can be aligned at an appropriate angle so that this angle enables the stiffness of the deformation element to be varied. Depending on the desired stiffness, an appropriate winding angle is then selected.

It is conceivable that the appropriate deformation is initiated mechanically in that, for example, a mechanical deformation at an appropriate point on the deformation element occurs. This mechanical deformation can propagate along the deformation element and is acquired at an appropriate point by the deformation sensor. The deformation can however also be initiated in other ways, such as for example, by magnetic forces. For this purpose, the deformation initiation element may be a magnetic ring surrounding the deformation element.

With this type of magnetic ring, or a magnetic body which only partially surrounds the deformation element, there is the possibility that it produces a deforming magnetic field by means of one or more appropriate windings. However, the deformation initiation element may also be a permanent magnet and especially a permanently magnetic ring. Examples of appropriate permanent magnets are especially those which contain neodymium. These magnets have a particularly strong magnetic field so that appropriate deformations can be initiated in an appropriate material of the deformation element by even a small magnet. Due to the appropriately strong magnetic field or the high energy density of this type of magnetic material, the rings can have suitably small dimensions, whereby the position determination can take place more accurately.

To produce an appropriate opposing magnetic field, which can produce a deformation of the deformation element through interaction with the magnetic field of the magnetic ring, at least one electrical winding can be arranged around the deformation element and extend in the direction of the movement of the body. Due to the appropriate winding, a magnetic field is produced with the application of a voltage or a current, the said magnetic field interacting with the magnetic field of the permanent magnet and causing a deformation of the deformation element due to the corresponding attraction or repulsion. This deformation then propagates from the point of the deformation initiation along the deformation element and the propagation time from the release or initiation point to the deformation sensor is measured and then converted into a corresponding relative position of the deformation element and deformation initiation element. The winding can be fitted directly on the deformation element and attached there. The winding can also be arranged spaced from the deformation element so that no mechanical contact is present and therefore mechanical decoupling is provided. If a coil or a winding of a number of single windings is used as the deformation element, then an additional winding for the production of the opposing magnetic field can be omitted.

It has already been pointed out above that the appropriate body, the position of which is to be determined, may be, for example, a spindle of a spindle drive of an actuator. The spindle here moves relative to an appropriate spindle nut and the relative position of both is determined. There is now the possibility that, on one hand, the deformation element is fixed and the deformation initiation element together with the body, i.e. in this case the spindle, moves. On the other hand, the deformation initiation element can also be fixed, whereby then the deformation element moves together with the body.

If the mentioned body is particularly a spindle of a spindle drive, it can exhibit a retaining hole extending in the longitudinal direction of the spindle for the displaceable mounting of the, at least partially, inserted deformation element. In this case the deformation initiation element is integrated into the spindle and, for example, mounted, in particular releasably, at one of its ends. Of course, the deformation initiation element can also be integrated into the spindle at another location.

In order to be able to better protect the deformation element, it can be enclosed in a protective sleeve.

In order to enable the redundant determination of the position, at least two deformation elements can be inserted into one another, whereby appropriate deformations can be initiated in each of these deformation elements by especially only one deformation initiation element. A corresponding deformation sensor can be assigned to each of the deformation elements. The assignment can take place at different points for each of the deformation elements.

A redundant version of the position determination device can also be realised in that at least two deformation elements are arranged adjacently. Also in this case, two deformation elements can be contained in one protective sleeve and the corresponding deformations of each deformation element can be initiated by one deformation initiation element.

It may be convenient, according to the invention, if the deformation can be converted into a sound wave propagating along the deformation element, in particular longitudinally. The sound wave is a mechanical vibration which propagates from the centre of excitation at which the deformation is initiated and exhibits a corresponding elongation and propagation speed. The sound wave can propagate here as a longitudinal wave, whereby appropriate small particles of the deformation element oscillate in the propagation direction. There is also the possibility that sound waves in the form of transverse or torsion waves arise.

From the centre of excitation appropriate oscillations propagate as sound waves in both directions along the deformation element. It is possible that a further deformation sensor is assigned to the other end opposite the measuring end of the deformation element in order to determine the propagation times of the corresponding sound waves by the deformation sensors assigned to the relevant ends. The sensors are in this connection, for example, temporally synchronised by the time point of the initiation of the deformation. There is also the possibility that sound waves with appropriate propagation times can be acquired directly and reflected from the reflection end of the deformation element remote from the deformation sensor. This means that not only is the sound wave propagating directly from the centre of excitation in the direction of the deformation sensor acquired, but rather the sound wave that propagates first in the direction of the reflecting end where it is reflected and then along the deformation element in the direction of the deformation sensor.

In order to especially briefly initiate a deformation in the deformation element, the electrical winding of the deformation element can be supplied with current and/or voltage pulses. This type of pulse results briefly in a magnetic field which interacts with the magnetic field of the electromagnetic ring at the excitation point, causing a deformation. Depending on the interaction of the magnetic fields, this can be caused by attraction or repulsion, so that either the deformation element is displaced in the direction of the permanently magnetised ring or compressed in the opposite direction.

This corresponding displacement then continues as a sound wave along the deformation element.

There is also the possibility that the corresponding pulses exhibit alternating arithmetic signs so that displacements in the direction of the magnetic ring and in the opposite direction alternate with one another.

In a preferred embodiment the deformation sensor can be a sensor with a piezoelectric element. This type of sensor comprises a piezo-ceramic which produces a voltage when an appropriate sound wave occurs. A simple arrangement of an appropriate sensor of piezo-ceramic can be provided when it is arranged at one end of the deformation element such that the propagation direction of the sound wave occurs perpendicular to a corresponding surface of the sensor.

In order to support the deformation element and, where applicable, also the protective sleeve, in particular with thin-walled material and to protect against bending, they can be inserted into or plugged onto a holding bushing with their reflection end remote from the deformation sensor.

Furthermore, the holding bushing can also exhibit a plug-on section for particularly sealed plugging of one end of the protective sleeve and an end section formed with a larger diameter in comparison to the diameter of the plug-on section. The end section is used for guiding the deformation element in the protective sleeve within the retaining hole of the spindle. On the end of the plug-on section opposite the end section the deformation element or elements are inserted with their reflection ends into appropriate ring-shaped receptacles.

In order to also hold the deformation element and protective sleeve securely opposite the holding bushing, a retaining end sleeve is arranged in which the deformation element, protective sleeve and deformation sensor are arranged, especially sealed. The deformation element or elements and the protective sleeve are inserted with their ends into the retaining end sleeve and a deformation sensor is assigned to each of the corresponding measurement ends of the deformation element or elements.

In order to protect the deformation sensor as well as the windings from especially external influences in the region of the measurement end, at least the measurement end and the associated deformation sensor are potted within the retaining end sleeve. A suitable material for potting is, for example, epoxy resin or a similar compound.

With this potting, in order to also protect the electrical connections to cables in this region, electrical cables for the electrical winding and the deformation sensor can be brought out of the retaining end sleeve.

In the following, advantageous embodiments of the invention are explained in more detail based on the figures enclosed in the drawing.

The following are shown:

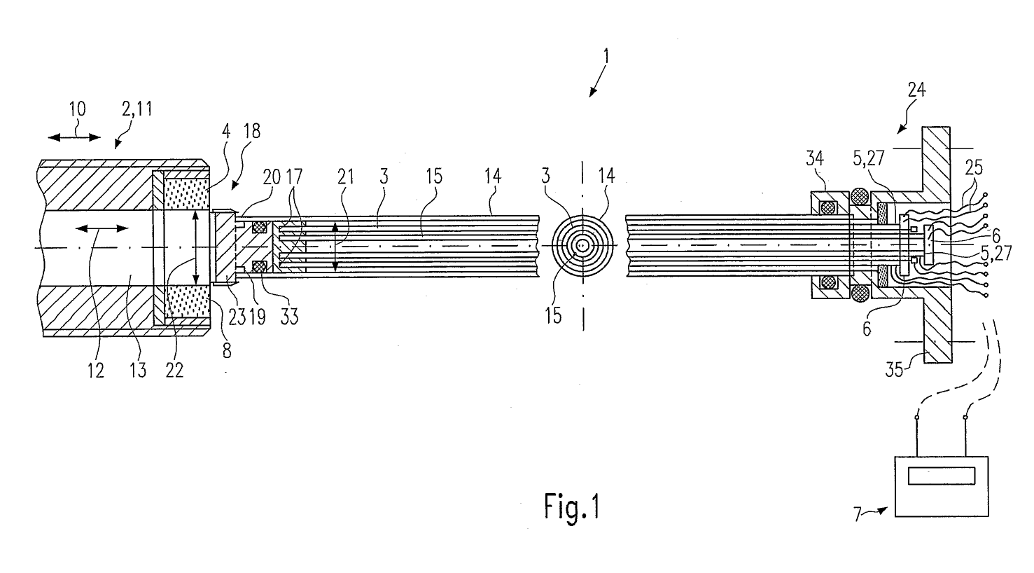

FIG. 1 a side sectional view of an embodiment of the position determination device according to the invention;

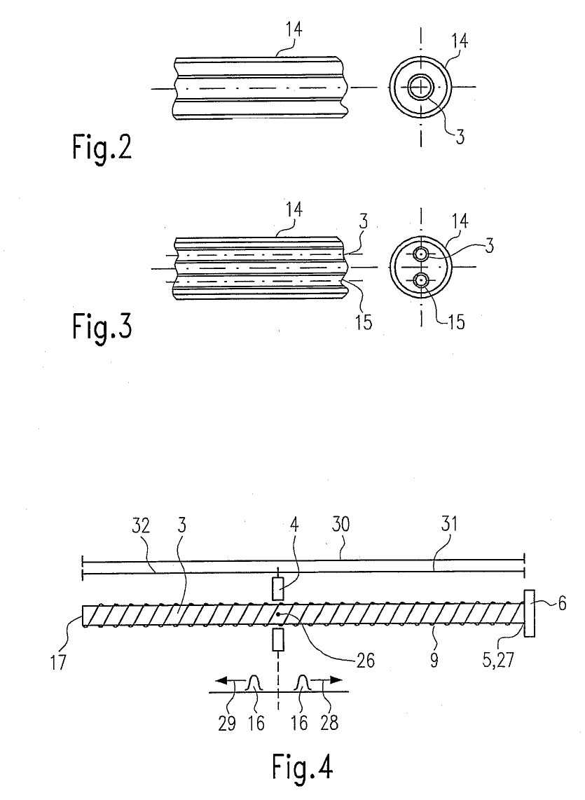

FIG. 2 a partial view of a second embodiment of a position determination device analogous to FIG. 1;

FIG. 3 a partial view of a third embodiment of a position determination device analogous to FIG. 1, and

FIG. 4 a schematic illustration of the position determination device for explaining the measurement principle.

FIG. 1 shows a side view of a longitudinal section through a first embodiment of a position determination device 1 according to the invention. This said device exhibits at least one deformation element 3 and a deformation initiation element 4 which are movable relative to one another in the body movement directions 10. The deformation initiation element 4 is formed as a magnetic ring 8 which is inserted into one end of a body 2. In the illustrated embodiment, this body 2 is a spindle 11. In the longitudinal direction 12 of the spindle, this spindle exhibits a retaining hole 13 in which the deformation element or elements 3 and 15 are supported for displacement and are at least partially inserted.

For better clarity, in FIG. 1 the deformation element 3, 15 is completely withdrawn from the retaining hole 13.

The spindle 11 is partially illustrated and, together with a spindle nut which is not shown, forms a screw drive for an actuator in the field of mineral oil and natural gas production.

These types of actuators are used for the adjustment of valves, blowout preventers, throttles or similar equipment. For example, in the case of a valve the spindle 11 can be connected for movement to an appropriate valve element which controls a flow of mineral oil through a pipe.

The magnetic ring 8 as deformation initiation element 4 is formed from a permanent magnetic material which, for example, contains neodymium and exhibits a high magnetic field strength and a high energy density.

The deformation element 3 is inserted with its reflection end 17 into an essentially ring-shaped retaining groove in one end of a holding bushing 18. Analogously, a corresponding reflection end 17 of another deformation element 15 is also inserted into an annular groove in this holding bushing 18. In the region of these annular grooves and also adjacent to it, the holding bushing 18 is formed with a diameter 21 which essentially corresponds to an internal diameter of a protective sleeve 14. In this protective sleeve 14 both deformation elements 3 and 15 are arranged plugged into one another, see also the lateral cross-sectional view shown in the centre in FIG. 1.

The region of the holding bushing 18 with diameter 21 is formed as a plug-on section 19 onto which one end 20 of the protective sleeve 14 is plugged in a sealed manner. Sealing can be provided in particular by an O-ring 33. Adjacent on the plug-on section 19, an end section 23 is arranged, which, in comparison to the diameter 21, exhibits a larger diameter 22. Consequently, a step is produced between the plug-on section 19 and the end section 23, the said step acting as a support surface for the end 20 of the protective sleeve 14. The diameter 22 of the end section 23 corresponds approximately to an internal diameter of the retaining hole 13.

Opposite the reflection end 17 each deformation element 3, 15 exhibits a measurement end 5. A deformation sensor 6 is assigned to each of these said ends. The deformation sensor 6 of the outer deformation element 3 is formed ring-shaped and surrounds the inner deformation element 15 which is passed through its annular opening. On its measurement end the other deformation sensor 6 is arranged with an essentially circular shape. Also, the protective sleeve 14 is inserted up to the retention sleeve 24 and is sealed there using another O-ring 34. On its end remote from the protective sleeve 14, the retaining end sleeve 24 exhibits an annular flange 35 for releasable mounting. The corresponding measurement ends 5 of the deformation elements 3, 15 and the associated deformation sensors 6 are potted for sealing within the retaining end sleeve 24 by, for example, epoxy resin.

Electrical cables 25 are routed to the windings 9, see FIG. 4, as well as to the deformation sensors 6 and are connected at the other end to an evaluation unit 7 which is only illustrated schematically.

The retaining end sleeve 24 is fixed with its annular flange 35, for example, within an appropriate actuator relative to the spindle 11 as a movable body 2 so that the deformation initiation element 4 moves along the deformation element 3 together with the body 2. Consequently, depending on the position of the body 2 and therefore of the deformation initiation element 4, a deformation of the corresponding deformation element 3, 15 is initiated at different initiation points or centres of excitation 26, see FIG. 4, the said deformation then propagating, particularly as a longitudinal sound wave 16, along the deformation element and being detected at the measurement end 5 as measuring point 27 by the corresponding deformation sensors 6. From the propagation time of the sound wave, arising due to the time difference between the initiation of the deformation and the detection by the deformation sensor, the position of the deformation initiation element 4 and therefore of the body 2 is determined relative to the deformation element 3.

In FIGS. 2 and 3 further embodiments of a position determination device 1 according to the invention are illustrated. They differ from the embodiment according to FIG. 1 in the number and/or arrangement of the deformation elements 3.

With the embodiment according to FIG. 2, a deformation element 3 is arranged within the protective sleeve 14, whereby both are arranged concentrically with respect to one another.

In the embodiment according to FIG. 3 two deformation elements 3, 15 are arranged adjacently and spaced from one another within the protective sleeve 14.

With the embodiments according to FIGS. 1 and 3, the position determination device is constructed redundantly, because two measurement values are determined in each case for the corresponding position. The other features of the embodiments according to FIGS. 2 and 3 correspond to those according to FIG. 1. Here, it should be noted that in the embodiments according to FIGS. 2 and 3 in each case approximately circular-shaped deformation sensors 6 are arranged on the corresponding measurement ends of the deformation elements 3.

FIG. 4 shows a schematic illustration of the position determination device for explaining the measurement principle.

In this figure the electrical winding 9 on the deformation element 3 can in particular be seen, the said winding having been omitted for simplification in FIGS. 1 to 3. With this electrical winding the corresponding electrical cables 25 are connected according to FIG. 1. Other cables are connected to the deformation sensor 6. The deformation initiation element 4 is arranged at an appropriate initiation point 26 for a deformation which is arranged at a distance 31 from the measuring point 27 of the deformation sensor 6 and at a distance 32 from the reflection end 17 of the deformation element 3. The total length 30 of the deformation element 3 corresponds to the sum of the corresponding distances 31 and 32.

Due to an appropriate current or voltage pulse which is passed to the electrical winding 9, a magnetic interaction of the magnetic field produced by the electrical winding 9 with the magnetic field of the magnetic ring of the deformation initiation element 4 occurs. Due to this interaction a brief displacement of the deformation element 3 arises, which after the end of the magnetic interaction propagates along the deformation element 3, especially as a longitudinal sound wave 16. Here, a sound wave, propagating directly in the direction of the deformation sensor 6 arises due to the deformation as well as a sound wave propagating in the direction of the reflection end 17, which only reaches the deformation sensor 6 at a later time point after reflection at the reflection end. The propagation times in each case for the sound waves are determined and are used to find the position of the deformation initiation element 4, employing the principle according to the following equations:
s₁=c_{L}*t₁ (1),
s₂=c_{L}*t₂ (2),
where s₁ corresponds to the distance 32 and s₂ to the distance 31 according to FIG. 4 with t₁ and t₂ being the corresponding propagation times and c_{L} is the speed of sound for a longitudinal sound wave.

The total length 30 of the deformation element 3 can be represented by the sum of equations (1) and (2) as follows:
2 l=s₁+s₂=c_{L}*t₁+c_{L}*t₂=c_{L}(t₁+t₂) (3).
From equation (3) the speed of sound is given as follows:
c_{L}=2 l/(t₁+t₂) (4).

By substituting equation (4) in equations (1) and (2) the said position of the deformation initiation element 4 relative to the reflection end 17 and to the measurement end 5 is given according to the following equations:
s₁=2 l*t₁/(t₁+t₂) (5),
and
s₂=2 l*t₂/(t₁+t₂) (6).

The speed of longitudinal sound waves, normally dependent on temperature, is eliminated in the position determination by measurements of the propagation time of the sound wave propagating directly in the direction of the measuring point 27 and of the sound wave first reflected, so that no temperature dependence is present in the said position determination. There is also the possibility of measuring the propagation times of both sound waves directly in that, for example, another deformation sensor 6 is assigned to the reflection end and the propagation time of the sound wave between the initiation point 26 and the reflection end 17 is measured. In this case the two sensors 6 are synchronised in time.

1. Position determination device for a linear moving body comprising: at least one deformation element extending along the range of body movement, a deformation initiation device movable relative to said deformation element, a deformation sensor assigned to a measurement end of the deformation element and an evaluation unit to determine the position of the linear moving body from a propagation time required from the deformation of the deformation initiation element to the deformation sensor.

2. Position determination device according to claim 1, wherein
the deformation element is substantially tubular shaped.

3. Position determination device according to claim 1 wherein
the deformation element is thin-walled.

4. Position determination device according to claim wherein
the deformation element is formed from solid material.

5. Position determination device according to claim wherein
the deformation element is formed as a coil or winding and the pitch of each single winding can be selected in relation to the stiffness of the deformation element.

6. Position determination device according to claim 1 wherein
the deformation initiation element is a magnetic ring surrounding the deformation element.

7. Position determination device according to claim 1 wherein
the deformation initiation element is a permanently magnetic ring.

8. Position determination device according to claim 1 wherein
at least one electrical winding is arranged around the deformation element and extends in the direction of the body movement.

9. Position determination device according to claim 8 wherein
the electrical winding is arranged spaced to the deformation element.

10. Position determination device according to claim 1 wherein
the deformation initiation element is arranged on the body.

11. Position determination device according to claim 1 wherein
the body is a spindle of a screw drive and includes a retaining hole extending in the longitudinal direction of the spindle for the displaceable support of the, at least partially, inserted deformation element.

12. Position determination device according to claim 1 wherein
the deformation element is surrounded by a protective sleeve.

13. Position determination device according to claim 12 wherein
at least two deformation elements are inserted one in the other.

14. Position determination device according to claim 12 wherein
at least two deformation elements are arranged adjacently.

15. Position determination device according to claim 1 wherein
the deformation can be converted into a sound wave propagating along the deformation element.

16. Position determination device according to claim 1 wherein
another deformation sensor is assigned to a reflection end situated opposite the measurement end of the deformation element.

17. Position determination device according to claim 16 wherein
the sound waves can be acquired with corresponding propagation times directly and reflected from the reflection end of the deformation element remote from the deformation sensor.

18. Position determination device according to claim 8 wherein
the electrical winding can be supplied with current and/or voltage pulses.

19. Position determination device according to claim 8 wherein
the electrical winding can be supplied with voltages with alternating arithmetic signs.

20. Position determination device according to claim 1 wherein
the deformation sensor is a piezoelectric element sensor.

21. Position determination device according to claim 1 wherein
the deformation element is inserted at a reflection end remote from the deformation sensor into a holding bushing.

22. Position determination device according to claim 21 wherein
the holding bushing includes a plug-on section for sealed plugging of an end of a protective sleeve and an end section formed with a diameter larger in comparison to the diameter of the plug-on section.

23. Position determination device according to claim 16 wherein
a retaining end sleeve is arranged opposite the reflection end, the deformation element, a protective sleeve and deformation sensor being arranged and sealed in the said retaining end sleeve.

24. Position determination device according to claim 23 wherein
at least the measurement end and the deformation sensor are potted within the retaining end sleeve.

25. Position determination device according to claim 8 wherein
electrical cables for the electrical winding and the deformation sensor are brought out from the retaining end sleeve and connected to an evaluation unit.

26. Position determination device according to claim 8 wherein
the electrical winding is insulated electrically with respect to the deformation element.

27. Method for position determination of a first body moving relative to a second body whereby a deformation element is assigned to one of the bodies and a deformation initiation element is assigned to the other body, the elements moving relative to one another analogous to the bodies, with the following steps:
i) induction of a brief deformation in the deformation element at an initiation point at which the deformation initiation element is located;
ii) measurement of a propagation time of at least one oscillation caused by the deformation along the deformation element at a measuring point of the deformation element using a deformation sensor, and
iii) calculation of the distance between the initiation point and the measuring point from the propagation time for the position determination of the first body relative to the second body.

28. Method according to claim 27, further including
initiation of the deformation by magnetic interaction between the deformation element and the deformation initiation element.

29. Method according to claim 27, further including
measurement of propagation times at least of an unreflected oscillation, propagating directly to the measuring point and a reflected oscillation, whereby the reflection occurs at a reflection end of the deformation element situated remotely from the measuring point.

30. Method according to one of the claim 27, further including
measurement of the propagation time at a measurement end of the deformation element, situated opposite the reflection end by the deformation sensor.

31. Method according to claim 27, further including
longitudinal sound wave measured as the oscillation.

32. Apparatus for determining the position of a spindle movable in an actuator, comprising:
at least one deformation element extending along the range of movement of the spindle;
a deformation initiation device movable with the spindle and movable relative to said deformation element, said deformation initiation device and deformation element generating a signal as said deformation initiation device moves relative to said deformation element;
a deformation sensor associated with the deformation element receiving said signal and transmitting said signal to an evaluation unit; and
said evaluation unit determining the position of the spindle from said signal.

33. Position determination device wherein the signal is one or more of an electrical signal, a magnetic signal, and a sound wave.
